(19) United States
(12) Patent Application Publication
(10) Pub. No.: US 2006/0140700 A1
(43) Pub. Date: Jun. 29, 2006

(54) Image forming device, computer system, and printing control and printing data processing methods using the same

(75) Inventors: Man-chan Kim, Suwon-si (KR); Myoung-jin Oh, Suwon-si (KR); Yu-rim Han, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/281,693

(22) Filed: Nov. 18, 2005

(30) Foreign Application Priority Data
Dec. 28, 2004 (KR) 2004-0113718

(51) Int. Cl. B41J 29/38

(52) U.S. Cl. 400/76

(57) ABSTRACT

An image forming device with a printing part to print printing data received from an external device is provided. The image forming device has a mode selector to allow a user to select one of a plurality of printing modes, and a controller. The controller creates a page image by processing the printing data on the basis of the printing mode selected through the mode selector while the printing data is printed on the basis of a predetermined printing mode, and controls the printing part to print the page image to allow a printing order to be inputted for changing a printing mode for document data, and a printing operation to be accomplished on the basis of the changed printing mode while the document data is printed.

### PRIORITY

This application claims the benefit under 35 U.S.C. § 119(a) of Korean Patent Application No. 2004-0113718, filed on Dec. 28, 2004, in the Korean Intellectual Property Office, the entire contents disclosure of which are incorporated herein by reference.

### BACKGROUND OF THE INVENTION

1. Field of the Invention

The present invention relates to an image forming device, a computer system, and printing control and printing data processing methods using the same. More particularly, the present invention relates to an image forming device, a computer system, and printing control and printing data processing methods using the same, in which a printing mode can be changed.

2. Description of the Related Art

In general, as shown in FIG. 1, a computer system to accomplish printing work comprises a computer 10, and a printer 20 electrically connected to the computer 10. The computer 10 has an application program 11 such as a word processor, and a printer driver 12. As shown in FIG. 2, in the computer system, the printing work is accomplished as follows. For example, when a user completes a document through the application program 11, at operation S10, a user inputs a printing order through the application program 11. Then, at operation S20, the application program 11 accesses the printer driver 12 to create, i.e., to code printing data corresponding to the document. At operation S30, the printing data is transmitted to the printer 20, and converted by a controller (not shown) provided in the printer 20 into a page image. Then., at operation S40, the printing work is started.

However, in the conventional computer system, once the printing order for color printing is inputted with regard to an electric document prepared in a color mode, it is not possible to change the color printing order into a black-and-white printing order. Color printing requires significantly more processing time and more ink than black-and-white printing. Thus, when a printing order for color printing is given in error and the color printing is not necessary, printing of the color printed document wastes both time and ink. Further, in the conventional computer system, there is no suitable printing option to print a portion of the color document by color printing, and to quickly print the other portion of the document by black-and-white printing, without the inconvenience of giving the printing order twice.

Further, even though a user wants to print the printing data by changing its resolution from a high resolution to a low resolution, it is impossible to change the resolution of the printing data once the printing work commences.

### SUMMARY OF THE INVENTION

Accordingly, it is an aspect of the present invention to provide an image forming device, a computer system, and printing control and printing data processing methods using the same, in which not only a printing order can be inputted for changing a printing mode for document data, but also a printing operation can be accomplished on the basis of the changed printing mode while the document data is printed.

The foregoing and/or other aspects of the present invention are also achieved by providing an image forming device with a printing part to print printing data received from an external device. The image forming device comprises a mode selector to allow a user to select one of a plurality of printing modes, and a controller to create a page image by processing the printing data on the basis of the printing mode selected through the mode selector while the printing data is printed on the basis of a predetermined printing mode, and to control the printing part to print the page image.

According to an aspect of the present invention, the printing mode comprises a color mode, a black-and-white mode, and a plurality of resolution mode.

According to an aspect of the present invention, the controller starts to process the printing data on the basis of the selected printing mode when the printing data passing to a new page is sensed.

The foregoing and/or other aspects of the present invention are also achieved by providing a computer system with a printer driver to create printing data by receiving document data, and creating a page image by processing the printing data on the basis of a predetermined printing mode. The computer system comprises a mode selector to allow a user to select one of a plurality of printing modes. The printer driver creates the page image by processing the printing data on the basis of the printing mode selected through the mode selector while the printing data is printed on the basis of the predetermined printing mode.

According to an aspect of the present invention, the printing mode comprises a color mode, a black-and-white mode, and a plurality of resolutions mode.

The foregoing and/or other aspects of the present invention are also achieved by providing a printing control method for an image forming device, comprising creating a page image by processing printing data received from an external device on the basis of a predetermined printing mode; selecting one of a plurality of printing modes while the printing data is printed on the basis of the predetermined printing mode; creating the page image by processing unprocessed data of the printing data on the basis of the selected printing mode; and printing the page image.

According to an aspect of the present invention, the printing mode comprises a color mode, a black-and-white mode, and a plurality of resolutions mode.

According to an aspect of the present invention, the step of creating the page image by processing the printing data on the basis of the selected printing mode comprises sensing that the received printing data passes to a new page; and starting to process the printing data on the basis of the selected printing mode when the printing data passing to the new page is sensed.

The foregoing and/or other aspects of the present invention are also achieved by providing a printing data processing method for a computer system, comprising the step of creating printing data by processing document data; creating a page image by processing the printing data on the basis of a predetermined printing mode; selecting one of a plurality of printing modes while the printing data is processed on the basis of the predetermined printing mode; and creating the page image by processing unprocessed data of the printing data on the basis of the selected printing mode.

According to an aspect of the present invention, the printing mode comprises a color mode, a black-and-white mode, and a plurality of resolutions mode.

### BRIEF DESCRIPTION OF THE DRAWINGS

The above and/or other aspects and advantages of the present invention will become apparent and more readily appreciated from the following description of the exemplary embodiments, taken in conjunction with the accompany drawings of which:

FIG. 1 is a block diagram of a conventional computer system;

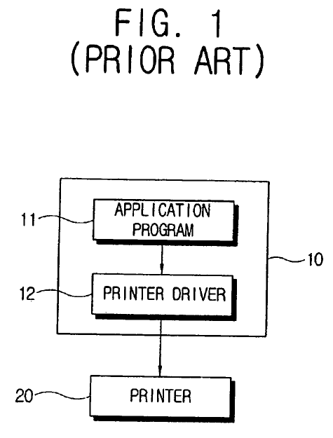

FIG. 2 is a flowchart of printing operation in the conventional computer system;

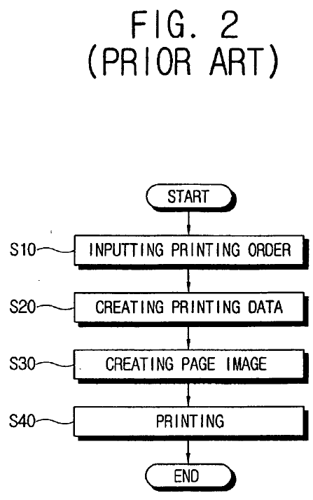

FIG. 3 is a block diagram of a computer system according to a first embodiment of the present invention;

FIG. 4 is a flowchart of printing operation in the computer system according to the first embodiment of the present invention;

FIG. 5 is a detailed flowchart for the operation S140 of FIG. 4; and

FIG. 6 is a block diagram of a computer system according to a second embodiment of the present invention.

### DETAILED DESCRIPTION OF THE EXEMPLARY EMBODIMENTS

Reference will now be made in detail to the embodiments of the present invention, examples of which are illustrated in the accompanying drawings, wherein like reference numerals refer to like elements throughout.

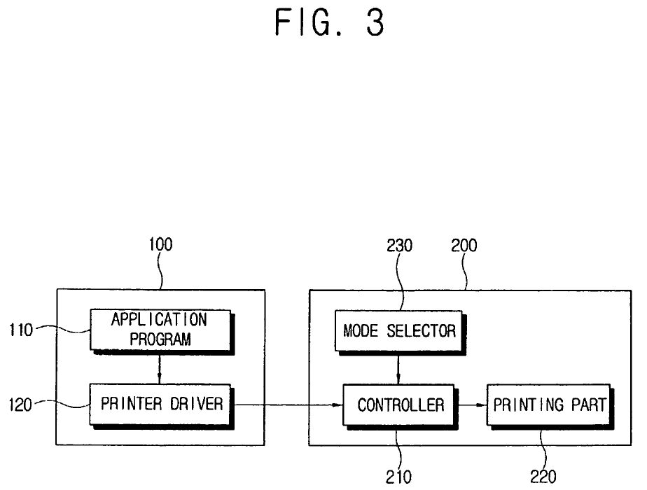

A first embodiment of the present invention will be described on the assumption that a printer driver employs a coder such as a printer control language (PCL), postscript, or the like. Referring to FIG. 3, a computer system according to the first embodiment of the present invention comprises a computer 100, and a printer 200 electrically connected to the computer 100. The computer 100 has an application program 110 such as a word processor, and a printer driver 120. The printer 200 comprises a controller 210 to process printing data received from the printer driver 120 of the computer 100, a printing part 220 to print the printing data on a sheet of paper according to control of the controller 210, and a mode selector 230 to change a printing mode.

The computer 100 comprises an input unit such as a keyboard, a mouse, or the like, a monitor used as a display device, and a computer main body having control and storage devices (not shown). Here, the application program 110 may vary according to document properties, e.g., a typical form document, a presentation document, a document with a chart and a graph, or etc. Also, the computer 100 has the printer driver 120 as a program to transfer the printing data to the printer 200. The printer driver 120 processes document data received from the application program 110, creates the printing data suitable for the printer 200, and transfers the printing data to the printer 200.

The controller 210 of the printer 200 receives the printing data from the printer driver 120 of the computer 100, and creates a bitmap image by processing the printing data. The bitmap image is transferred to and printed by the printing part 220. Through the mode selector 230, a user can select the bitmap image, which is being created for a predetermined printing mode, to be changed via another printing mode. Further, through the mode selector 230, a user can select the bitmap image, which is being created for the changed printing mode, to return to the previous printing mode.

On the way to printing, when a user selects change of the printing mode through the mode selector 230, the controller 210 processes the printing data received from the printer driver 120 depending on the changed printing mode identified via the user's selection, thereby creating the bitmap image. Further, after changing the printing mode, when a user selects the previous printing mode again to return to the previous printing mode through the mode selector 230, the controller 210 creates a corresponding bitmap image by returning to the previous printing mode based on the user's selection.

Depending on the user's selections, the controller 210 does not immediately create the bitmap image corresponding the changed printing mode even though the printing mode is changed through the mode selector 230, but rather waits until the printing data passes to a new page. Therefore, the controller 210 starts creating the bitmap image when the printing data passes to the new page, so that the image based on different printing modes is prevented from being printed on one page. That is, an image corresponding to only one printing mode is preferably printed per page.

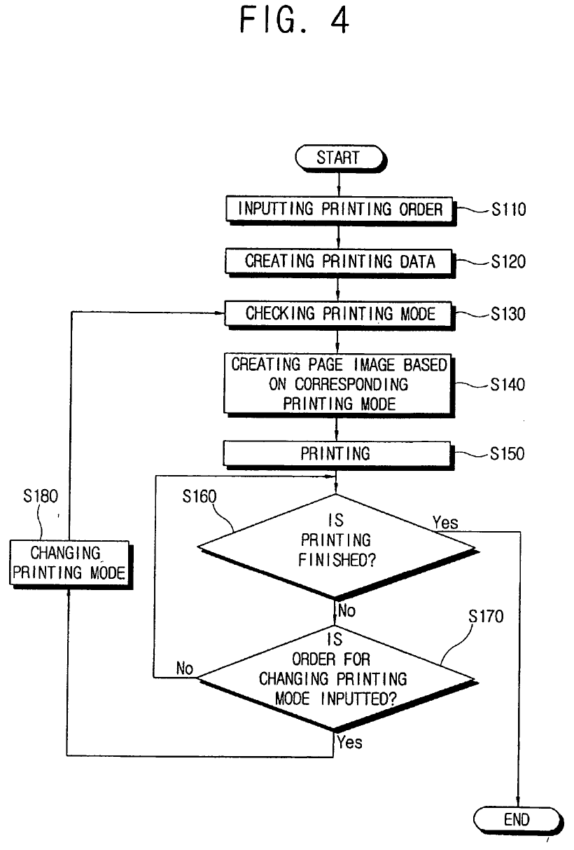

Hereinbelow, a printing operation using the computer system of FIG. 3 will be described by referring to FIG. 4. After completing the document data through the application program 110, at operation S110, a user inputs a printing order through the application program 110. Then, at operation S120, the application program 110 accesses the printer driver 120 to create, i.e., to code, the printing data having a predetermined printing mode on the basis of the document data. Then, the printing data is transferred from the printer driver 120 to the printer 200, and at operation S130, the controller 210 of the printer 200 determines the current printing mode. Then, at operation S140, the controller 210 of the printer 200 processes the received printing data on the basis of the determined printing mode, thereby creating a page image (i.e., bitmap image). At operation S150, the bitmap image created by the controller 210 is transferred to the printing part 220. The printing part 220.then prints the bitmap image.

Further, at operation S160, the controller 210 determines whether the printer 200 has finished the printing work. In the case where the printer 200 is operating, at operation S170, the controller 210 determines whether a user has input an order to change the printing mode through the mode selector 230. When the printing mode is changed (operation S180), at operation S130, the controller 210 determines the changed printing mode. Then, at operation S140, the controller 210 processes the printing data, which is received after changing the printing mode, on the basis of the changed printing mode, thereby creating the bitmap image. At operation S150, the bitmap image created by the controller 210 is transferred to the printing part 220, and thus the bitmap image is printed on the basis of the changed printing mode. Further, at operation S170, when a user inputs an order to return the changed printing mode to the previous printing mode while the printing data is processed on the basis of the changed printing mode, at operation S180, the controller 210 changes the printing mode into the previous printing mode. Then, returning to the operation S130, the controller 210 determines the returned printing mode. Then, at operation S140, the controller 210 processes the printing data, which is received after returning to the previous printing mode, on the basis of the returned printing mode, thereby creating the bitmap image.

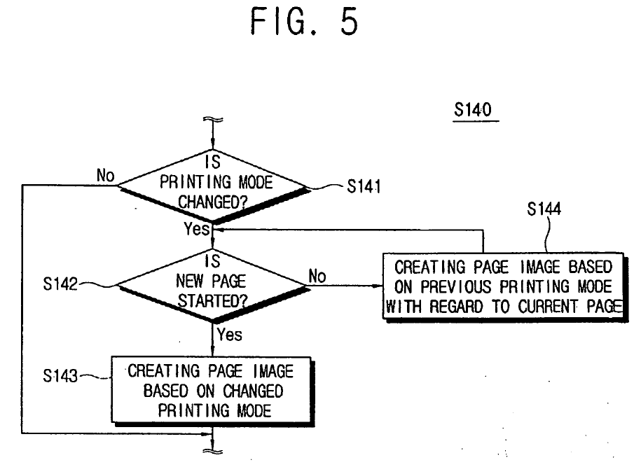

Here, the operation S140 for creating the page image is shown in more detail in FIG. 5. That is, at operation S141, the controller 210 determines whether the printing mode is changed. When the printing mode is changed, at operation S142, the controller 210 determines whether the printing data starts at a new page. When the printing data starts at a new page (i.e., when a page to be printed is passed to the next new page), at operation S143, the controller 210 creates the bitmap image based on the changed printing mode. On the other hand, in the case where the printing data does not match a new page, at operation S144, the controller 210 creates the bitmap image based on the unchanged printing mode. Thereafter, when the received printing data matches a new page, the controller 210 operates depending on the operation S143 and creates the bitmap image based on the changed printing mode. Referring to a series of the operations S141 through S144, when the printing mode is changed in the state that the printing work based on the previous printing mode is not finished with regard to one page, the printing work based on the previous printing mode is finished with regard to the current page, and then the changed printing mode is applied to the next page.

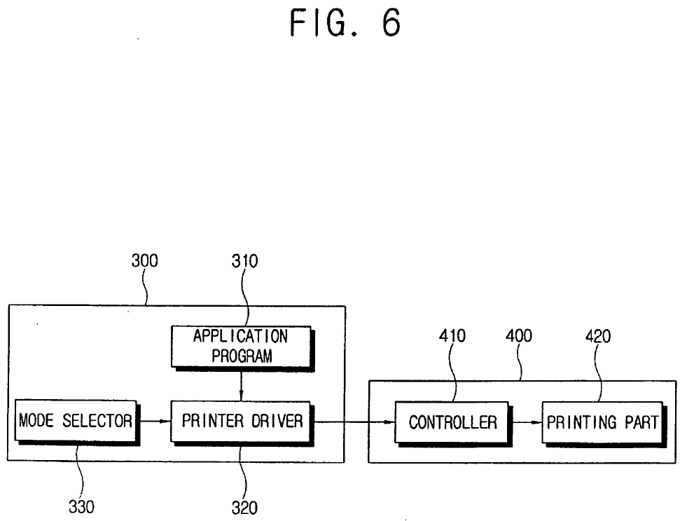

A second embodiment of the present invention will be described on the assumption that a printer driver employs a coder such as a graphic device interface (GDI) or the like. Referring to FIG. 6, a computer system according to the second embodiment of the present invention comprises a computer 300, and a printer 400 electrically connected to the computer 300. The computer 300 has an application program 310 such as a word processor, and a printer driver 320. Here, the printer driver 320 creates printing data based on document data received from the application program 310, and then creates a bitmap image based on the printing data.

Further, the computer 300 has a mode selector 330 for allowing a user to change a printing mode of the bitmap image being currently created by the printer driver 320 into another printing mode, or to return the changed printing mode to the previous printing mode while the bitmap image is created on the basis of the changed printing mode. Thus, the printer driver 320 creates the bitmap image by receiving the document data from the application program 310, and at the same time creates the changed bitmap image in response to a changing or returning signal for the printing mode from the mode selector 330.

In the meanwhile, a printing operation using the computer system according to the second embodiment of the present invention is the same as the first embodiment, except that the operation S150 of the first embodiment is performed in the printer 400 and the other operations are all performed in the printer driver 320 provided in the computer 300.

In the foregoing embodiment, changing the printing mode for the bitmap image can comprise changing a color mode into a black-and-white mode, returning the black-and-white mode to the color mode, changing a high resolution mode into a low resolution mode, and returning the low resolution mode to the high resolution mode, and so on.

As described above, the present invention provides an image forming device, a computer system, and printing control and printing data processing methods using the same, in which a printing mode can be changed while document data is printed on the basis of the printing mode, and thus printing work is accomplished on the basis of the changed printing mode, thereby increasing printing speed and economizing ink. Further, while the printing work is accomplished on the basis of the changed printing mode, it is possible to return to the previous printing mode, thereby applying a predetermined printing mode to a desired portion of the document data.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An image forming device with a printing part to print printing data received from an external device, the image forming device comprising:
a mode selector to allow a user to select one of a plurality of printing modes; and
a controller to create a page image by processing the printing data on the basis of the printing mode selected through the mode selector while the printing data is printed on the basis of a predetermined printing mode, and to control the printing part to print the page image.

2. The image forming device according to claim 1, wherein the printing mode comprises a color mode, a black-and-white mode, and a plurality of resolutions mode.

3. The image forming device according to claim 1, wherein the controller starts to process the printing data on the basis of the selected printing mode when the printing data passes to a new page.

4. The image forming device according to claim 2, wherein the controller starts to process the printing data on the basis of the selected printing mode when the printing data passes to a new page.

5. A computer system with a printer driver to create printing data by receiving document data and creating a page image by processing the printing data on the basis of a predetermined printing mode, the computer system comprising:
a mode selector to allow a user to select one of a plurality of printing modes,
wherein the printer driver creates the page image by processing the printing data on the basis of the printing mode selected through the mode selector while the printing data is printed on the basis of the predetermined printing mode.

6. The image forming device according to claim 5, wherein the printing mode comprises a color mode, a black-and-white mode, and a plurality of resolutions mode.

7. The image forming device according to claim 5, wherein the controller starts to process the printing data on the basis of the selected printing mode when the printing data passes to a new page.

8. The image forming device according to claim 6, wherein the controller starts to process the printing data on the basis of the selected printing mode when the printing data passes to a new page.

9. A printing control method for an image forming device, comprising:
creating a page image by processing printing data received from an external device on the basis of a predetermined printing mode;
selecting one of a plurality of printing modes while the printing data is printed on the basis of the predetermined printing mode;
creating the page image by processing unprocessed data of the printing data on the basis of the selected printing mode; and
printing the page image.

10. The image forming device according to claim 9, wherein the printing mode comprises a color mode, a black-and-white mode, and a plurality of resolutions mode.

11. The image forming device according to claim 9, wherein the step of creating the page image by processing the printing data on the basis of the selected printing mode comprises:
sensing that the received printing data passes to a new page; and
starting to process the printing data on the basis of the selected printing mode when the printing data passing to the new page is sensed.

12. The image forming device according to claim 10, wherein the step of creating the page image by processing the printing data on the basis of the selected printing mode comprises:
sensing that the received printing data passes to a new page; and
starting to process the printing data on the basis of the selected printing mode when the printing data passing to the new page is sensed.

13. A printing data processing method for a computer system, comprising:
creating printing data by processing document data;
creating a page image by processing the printing data on the basis of a predetermined printing mode;
selecting one of a plurality of printing modes while the printing data is processed on the basis of the predetermined printing mode; and
creating the page image by processing unprocessed data of the printing data on the basis of the selected printing mode.

14. The image forming device according to claim 13, wherein the printing mode comprises a color mode, a black-and-white mode, and a plurality of resolutions mode.

15. The image forming device according to claim 13, wherein the step of creating the page image by processing the printing data on the basis of the selected printing mode comprises:
sensing that the printing data passes to a new page; and
starting to process the printing data on the basis of the selected printing mode when the printing data passing to the new page is sensed.

16. The image forming device according to claim 14, wherein the step of creating the page image by processing the printing data on the basis of the selected printing mode comprises:
sensing that the printing data passes to a new page; and
starting to process the printing data on the basis of the selected printing mode when the printing data passing to the new page is sensed.
